(19) United States
(12) Patent Application Publication
(10) Pub. No.: US 2025/0026415 A1
(43) Pub. Date: Jan. 23, 2025

(54) LIFT ASSIST SYSTEMS FOR MOTOR VEHICLES

(71) Applicant: FORD GLOBAL TECHNOLOGIES, LLC, Dearborn, MI (US)

(72) Inventor: Amol BORKAR, Dearborn, MI (US)

(21) Appl. No.: 18/356,692

(22) Filed: Jul. 21, 2023

(51) Int. Cl. B62D 33/027; E05F 1/12

(52) U.S. Cl. CPC B62D 33/027; E05F 1/1292; E05Y 2201/604; E05Y 2201/624; E05Y 2900/544; E05Y 2900/546

(57) ABSTRACT

Lift assist systems are provided for use with motor vehicle assemblies. An exemplary lift assist system may include features for reducing the rate at which a tailgate pivots open and reducing the amount of force required to pivot the tailgate closed.

### TECHNICAL FIELD

This disclosure relates generally to motor vehicles, and more particularly to lift assist systems for a closure member of the vehicle.

### BACKGROUND

Many vehicles include a tailgate disposed at a rear of the vehicle. The tailgate can include added features that increase the weight of the tailgate, thereby making the tailgate open too quickly or be too difficult to close.

### SUMMARY

In some aspects, the techniques described herein relate to a vehicle assembly, including: a tailgate configured to pivot between a closed position and an open position; and a lift assist system connected to the tailgate and including a torsion rod and a nitrogen gas strut, wherein the lift assist system is configured such that, when the tailgate is pivoted from the open position to the closed position, the torsion rod applies a first force on the tailgate and the nitrogen gas strut applies a second force on the tailgate.

In some aspects, the techniques described herein relate to a vehicle assembly, wherein the torsion rod extends between a first end that is rotatably attached to a support assembly and a second end that is fixedly attached to a clamp box.

In some aspects, the techniques described herein relate to a vehicle assembly, wherein the support assembly includes a flange and a shaft that extends through the flange and rotates relative to the flange, and the first end includes an attachment sleeve that is configured to receive the shaft.

In some aspects, the techniques described herein relate to a vehicle assembly, wherein the clamp box is secured to a lower wall of the tailgate.

In some aspects, the techniques described herein relate to a vehicle assembly, wherein, when the tailgate is pivoted between the closed position and the open position, the second end does not rotate relative to the clamp box.

In some aspects, the techniques described herein relate to a vehicle assembly, wherein the nitrogen gas strut includes a first end that is pivotably attached to a support assembly and a second end that is fixedly attached to a vehicle endwall.

In some aspects, the techniques described herein relate to a vehicle assembly, wherein the vehicle endwall is a laterally extending surface of a vehicle sidewall.

In some aspects, the techniques described herein relate to a vehicle assembly, wherein the second end is above a vehicle bumper.

In some aspects, the techniques described herein relate to a vehicle assembly, wherein the support assembly includes a bracket, a support, a cup, a flange, and a bell crank.

In some aspects, the techniques described herein relate to a vehicle assembly, wherein the nitrogen gas strut is mounted in an open area defined by a vehicle sidewall and an outer panel of a vehicle body.

In some aspects, the techniques described herein relate to a vehicle assembly, including: a tailgate positioned between a first vehicle sidewall and a second vehicle sidewall, the tailgate configured to pivot between a closed position and an open position; a torsion rod rotatably attached at a first end to the first vehicle sidewall and fixedly attached at an opposite, second end to a clamp box; and a nitrogen gas strut pivotably attached at a first end to the tailgate and fixedly attached at an opposite, second end to a portion of the second vehicle sidewall.

In some aspects, the techniques described herein relate to a vehicle assembly, wherein the first end of the torsion rod extends through a first side of the tailgate and is attached to a support assembly that is secured to the first vehicle sidewall.

In some aspects, the techniques described herein relate to a vehicle assembly, wherein the support assembly includes a flange and a shaft that extends through the flange and rotates relative to the flange, and the shaft is received within an attachment sleeve of the first end.

In some aspects, the techniques described herein relate to a vehicle assembly, wherein the second end of the torsion rod includes an attachment section that is received within a channel of the clamp box so that the second end does not rotate relative to the clamp box.

In some aspects, the techniques described herein relate to a vehicle assembly, wherein the first end of the nitrogen gas strut is attached to a support assembly that is secured to the tailgate.

In some aspects, the techniques described herein relate to a vehicle assembly, wherein the support assembly includes a bracket, a support, a cup, a flange, and a bell crank.

In some aspects, the techniques described herein relate to a vehicle assembly, wherein the support includes a slot that is configured to receive a shaft that extends through a second side of the tailgate and the bracket.

In some aspects, the techniques described herein relate to a vehicle assembly, wherein a drive rod extends through the support and the bell crank, and the bell crank includes a post that is attached the second end of the nitrogen gas strut.

In some aspects, the techniques described herein relate to a vehicle assembly, wherein the second end of the nitrogen gas strut is above a vehicle bumper.

In some aspects, the techniques described herein relate to a vehicle assembly, wherein the nitrogen gas strut is mounted in an open area defined by the second vehicle sidewall and an outer panel of a vehicle body. LIFT ASSIST SYSTEMS FOR MOTOR VEHICLES

### BRIEF DESCRIPTION OF THE DRAWINGS

FIG. 1 schematically illustrates select portions of an exemplary vehicle.

FIG. 2 illustrates an exemplary tailgate of the vehicle of FIG. 1 in an open position.

FIG. 3 illustrates an exemplary torsion rod of an exemplary tailgate of the vehicle of FIG. 1.

FIG. 4 illustrates one end of the exemplary torsion rod of FIG. 3.

FIG. 5 illustrates another end of the exemplary torsion rod of FIG. 3.

FIG. 6 illustrates an exemplary nitrogen gas strut of the exemplary tailgate of the vehicle of FIGS. 1 and 2.

FIG. 7 is a perspective view of the exemplary nitrogen gas strut of FIG. 6.

FIG. 8 illustrates an exemplary bracket and an exemplary support assembly that are configured to attach the exemplary nitrogen gas strut to the exemplary tailgate.

FIG. 9 is a perspective view of the exemplary support assembly of FIG. 7.

FIG. 10 illustrates a first position of an exemplary nitrogen gas strut.

FIG. 11 illustrates a second position of an exemplary nitrogen gas strut.

FIG. 12 illustrates select portions of another exemplary vehicle.

### DETAILED DESCRIPTION

This disclosure details lift assist systems for controlling movement of vehicle tailgates. Exemplary lift assist systems may include a torsion rod and a nitrogen gas strut. The torsion rod and the nitrogen gas strut may include features for reducing the force needed to move the vehicle tailgate from an open position to a closed position. In some implementations, the torsion rod may be configured to apply a first force on the tailgate, and the nitrogen gas strut may be configured to apply a second force on the tailgate. These and other features are discussed in greater detail in the following paragraphs of this detailed description.

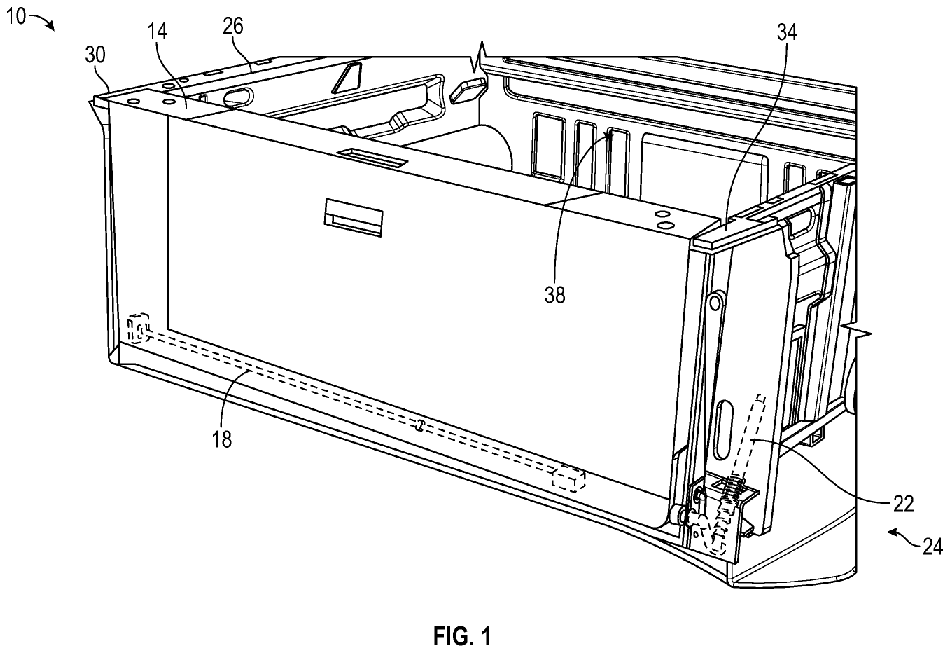

FIG. 1 schematically illustrate select portions of a vehicle 10. The vehicle 10 may include a closure member, here a tailgate 14, a torsion rod 18, and a nitrogen gas strut 22. As discussed further below, the torsion rod 18 and the nitrogen gas strut 22 may be configured to establish a lift assist system 24 that can both reduce the rate at which the tailgate 14 pivots open and reduce the amount of force required to pivot the tailgate 14 closed. Together, the tailgate 14 and the lift assist system 24 establish a vehicle assembly of the vehicle 10.

In the illustrated embodiment, the vehicle 10 is depicted as a pickup truck. However, the vehicle 10 could alternatively be a car, a van, sports utility vehicle (SUV), or any other vehicle configuration. Although a specific component relationship is illustrated in the figures of this disclosure, the illustrations are not intended to limit this disclosure. The placement and orientation of the various components of the vehicle 10 are shown schematically and could vary within the scope of this disclosure. In addition, the various figures accompanying this disclosure are not necessarily drawn to scale, and some features may be exaggerated or minimized to emphasize certain details of a particular component or system.

The tailgate 14 is located at the rear of the vehicle 10, in this example, and may be positioned between a pair of vehicle sidewalls of a vehicle body 26. More specifically, one end of the tailgate 14 is adjacent a first vehicle sidewall 30 and another, opposite end of the tailgate 14 is adjacent a second vehicle sidewall 34.

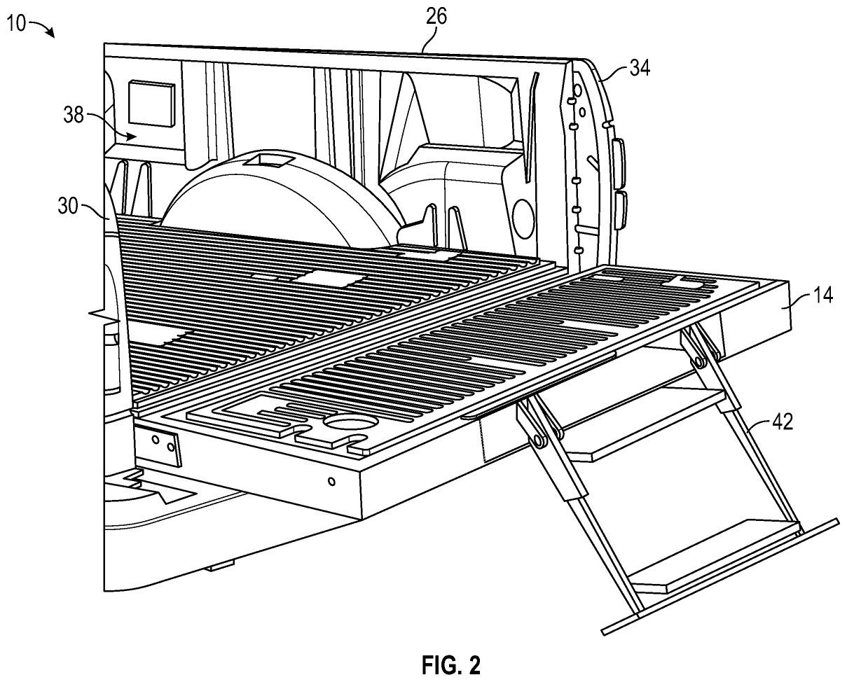

The tailgate 14 may be pivoted relative to the vehicle body 26 between a closed position shown in FIG. 1 and an open position shown in FIG. 2. When in the closed position, the tailgate 14 provides a barrier between the exterior of the vehicle 10 and a vehicle cargo space 38, such as a vehicle bed. When in the open position, the tailgate 14 permits users to access the vehicle cargo space 38.

The tailgate 14 may include an integrated accessory component 42, such as a step ladder, for example, which may be deployed when the tailgate 14 is in the open position. In some examples, the accessory component 42 may increase the weight of the tailgate 14, thereby making the tailgate 14 open more quickly or be more difficult to close. The lift assist system 24 may therefore be provided on the vehicle 10 for facilitating a more positive user experience when opening or closing the tailgate 14.

The torsion rod 18 of the lift assist system 24 may be mounted at least partially within the tailgate 14. In this example, the torsion rod 18 extends longitudinally within the tailgate 14.

The nitrogen gas strut 22 of the lift assist system 24 may be mounted outboard of the tailgate 14. In this example, the nitrogen gas strut 22 is mounted adjacent to the second vehicle sidewall 34.

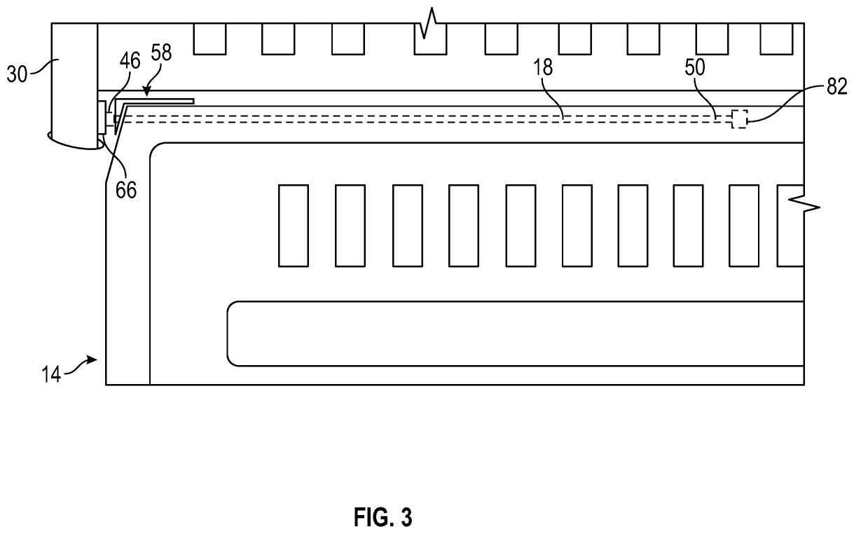

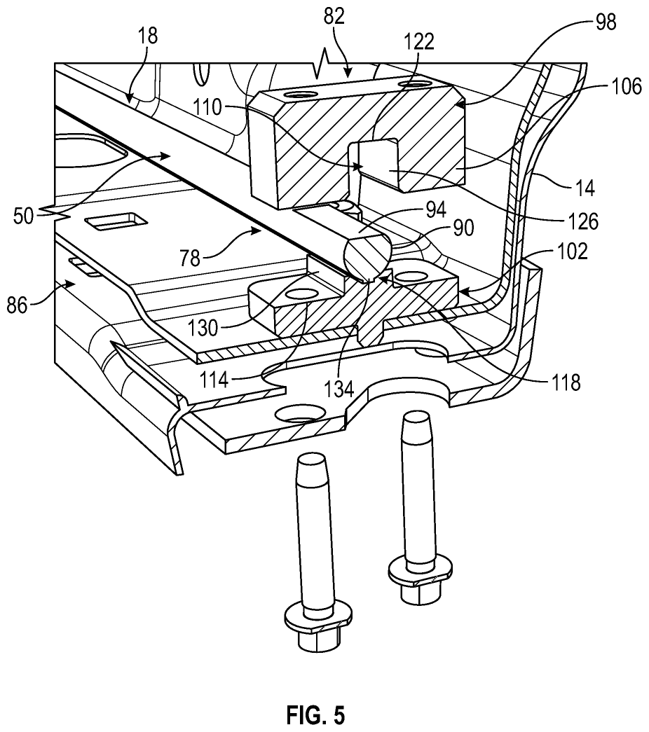

FIGS. 3-5 illustrate additional details associated with the torsion rod 18 of the exemplary lift assist system 24 of FIG. 1. The torsion rod 18 may extend between a first end 46 and a second end 50. The first end 46 may extend through a first side 54 of the tailgate 14, and then through a bracket 58, which may be secured (e.g., bolted, welded, adhered, etc.) to the first side 54.

The first end 46 of the torsion rod 18 may include an attachment sleeve 62 for rotatably attaching to the first vehicle sidewall 30 via a support assembly 66. The support assembly 66 may include a rotatable shaft 70 and a flange 74. The rotatable shaft 70 extends through the flange 74, in this example. The rotatable shaft 70 may rotate relative to the flange 74. The attachment sleeve 62 is generally cylindrically shaped and may include a bore 78 for receiving the rotatable shaft 70. The rotatable shaft 70 may be constructed to correspond to the shape of the attachment sleeve 62. The flange 74 may include a groove 82 for retaining the rotatable shaft 70 against the flange 74. The flange member 74 may be secured (e.g., bolted, welded, adhered, etc.) to the first vehicle sidewall 30 of the vehicle body 26 so that the torsion rod 18 can rotate relative to the first vehicle sidewall 30.

The second end 50 of the torsion rod 18 may include an attachment section 78 for fixedly attaching to a clamp box 82. The clamp box 82 may be secured (e.g., bolted, welded, adhered, etc.) to a surface, here a lower wall 86 of the tailgate 14 in this example. In other examples, the clamp box 82 could be secured to other portions of the vehicle body 26 including but not limited to the second vehicle sidewall 34, inner panel sheet metal sections, and inner and/or outer hinge reinforcements. The attachment section 78 may include a curved portion 90 and a flat portion 94 that is substantially flat relative to the curved portion 90 and the generally cylindrical shape of the torsion rod 18.

The clamp box 82 may include a first section 98 and a second section 102 that cooperate for receiving the attachment section 78 of the second end 50. A lower side 106 of the first section 98 may provide a channel 110 for receiving the flat portion 94, and an upper side 114 of the second section 102 may provide a channel 118 for receiving the curved portion 90. In this example, the channel 110 is generally U-shaped, and the channel 118 is generally arc-shaped.

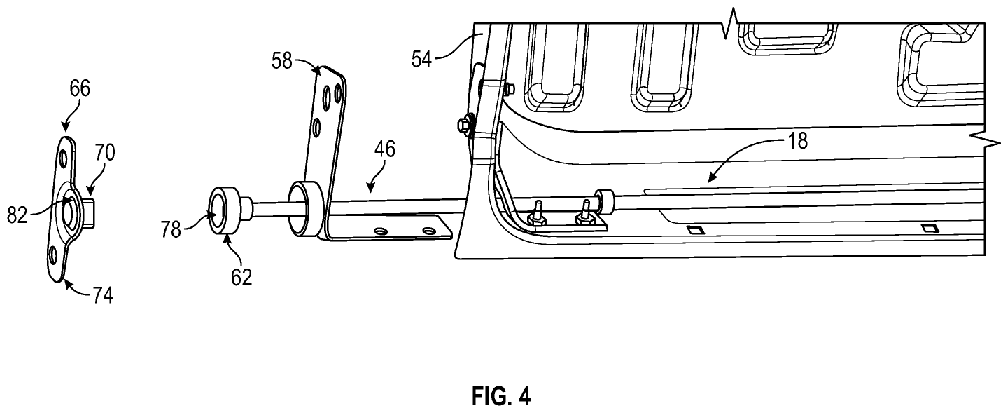

When the attachment section 78 is installed between the first section 98 and the second section 102, the flat portion 94 may abut an upper wall 122 of the channel 110, opposed sidewalls 126 of the channel 110 may abut opposed sidewalls 130 of the channel 118, and the curved portion 90 of the attachment section 78 may abut a lower wall 134 of the channel 118 so that the attachment section 78 is fixed from rotation relative to the clamp box 82. However, the clamp box 82 may cause the torsion rod 18 to pivot with the tailgate 14. For example, if the clamp box 82 is secured to the lower wall 86 of the tailgate 14, the clamp box 82 may pivot with the tailgate 14 between the closed position and the open position. With the attachment section 78 unable to rotate within the clamp box 82, the torsional force is transferred to the first end 46 of the torsion bar 18, which then causes the attachment sleeve 62 to rotate with the rotatable shaft 70 relative to the first vehicle sidewall 30 of the vehicle body 26 (see FIG. 4).

The torsion rod 18 may be configured to assist a user when lifting the tailgate 14. For example, when a user pivots the tailgate 14 from the closed position to the open position, the second end 50 of the torsion rod 18 and the clamp box 82 move with the tailgate 14, which causes the first end 46 of the torsion rod 18 and the attachment sleeve 62 to rotate with the rotatable shaft 70 relative to the first vehicle sidewall 30 (see FIG. 4). This action causes internal components of the torsion rod 18 to store torsional energy. When the user subsequently pivots the closure member 14 from the open position back to the closed position, the torsion rod 18 releases the stored energy and applies a first force on the tailgate 14. The first force may be a spring-like force that reduces the external force needed for the user to move the closure member 14 back to the closed position.

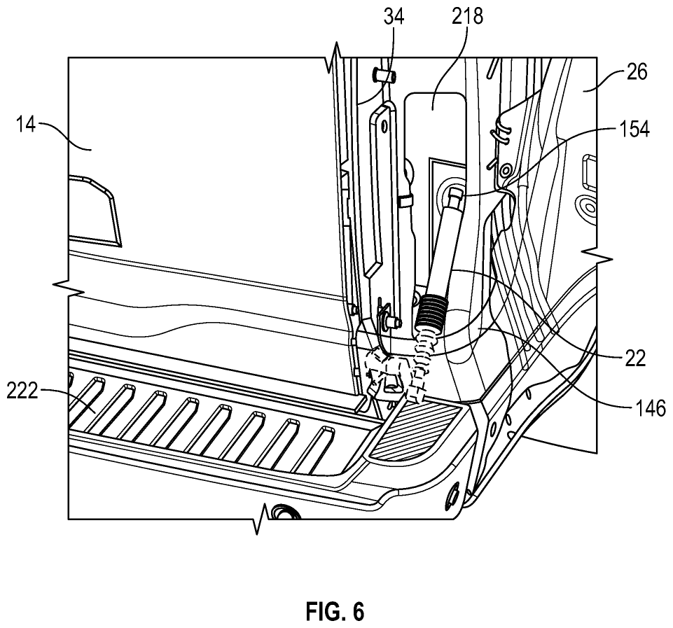

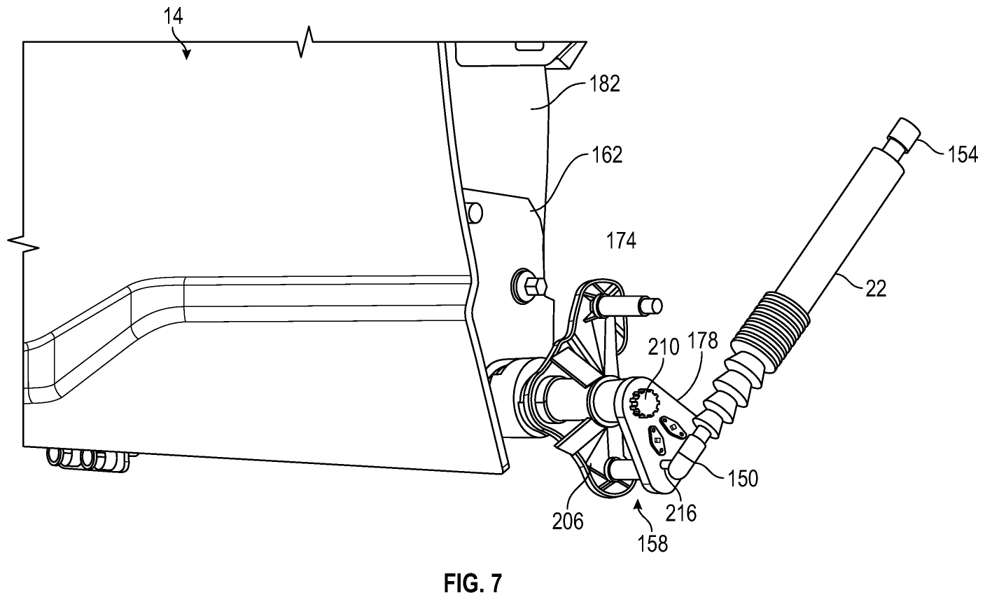

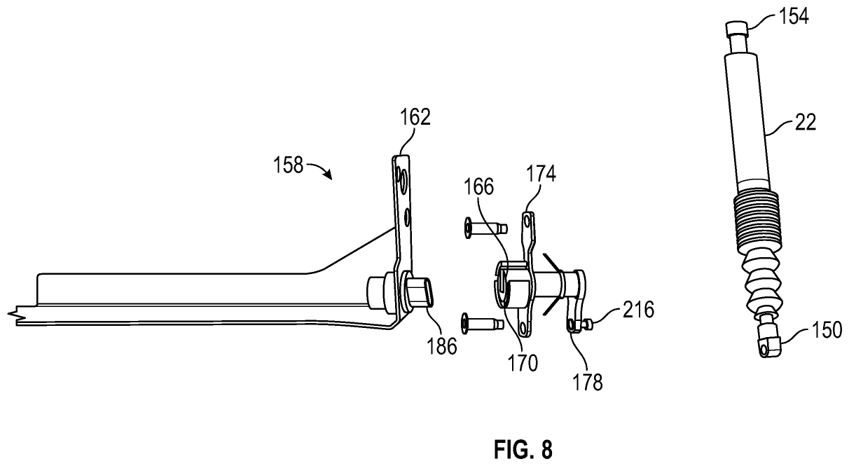

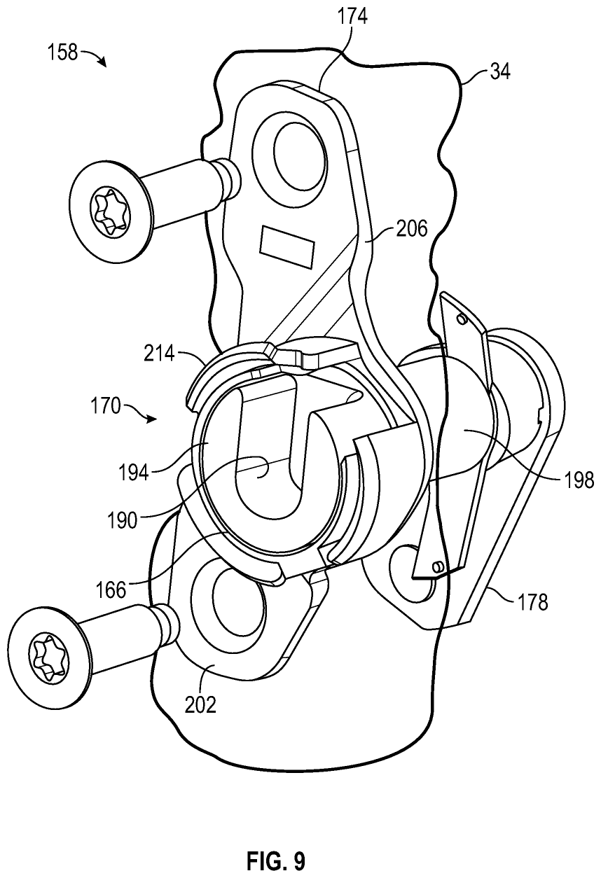

FIGS. 6-9 illustrate additional details associated with the nitrogen gas strut 22 of the exemplary lift assist system 24 of FIG. 1. The nitrogen gas strut 22 may be mounted within an open area 142 defined by the second vehicle sidewall 34 and an outer panel 146 of the vehicle body 26. The outer panel 146 may form an outer contour of the vehicle body 26. The nitrogen gas strut 22 may be concealed by other components (e.g., a taillight) and is therefore generally not visible from exterior of vehicle 10.

The nitrogen gas strut 22 may include a first end 150 and a second end 154. The first end 150 may be pivotably attached to a support assembly 158. The support assembly 158 may include a bracket 162, a support 166, a cup 170, a flange 174, and a bell crank 178.

The bracket 162 may be secured (e.g., bolted, welded, adhered, etc.) at a second side 182 of the tailgate 14 and thus may move with the tailgate 14 relative to the second vehicle sidewall 34. The bracket 162 may include a shaft 186 for attaching to the support 166. The shaft 186 is fixed and thus does not pivot relative to the bracket 162. The shaft 186 extends through an opening defined at the second side 182 and then through the bracket 162 in this example. A portion of the shaft 186 may be received in a slot 190 of the support 166. The support 166 may include a first section 194 and a second section 198. The first section 194 may extend laterally outward away from an inboard facing side 202 of the flange 174. The first section 194 may be pivotably attached to the bracket 162 when the shaft 186 is in the slot 190. The second section 198 may extend laterally outward away from an outboard facing side 206 of the flange 174. The second section 198 may be pivotably attached to the bell crank 178 via a drive rod 210. The drive rod 210 may extend through the cup 170, the flange 174, and the bell crank 178.

The cup 170 may be secured (e.g., welded, adhered, etc.) to the flange 174, which is secured (e.g., bolted, welded, adhered, etc.) to the second vehicle sidewall 34. As a result, the cup 170 does not rotate relative to the support 166 and the flange 174. The cup 170 may include one or more portions 214 that extend laterally outward away from the inboard facing side 202 of the flange 174 and at least partially surround the support 166.

The bell crank 178 may include a post 216 for pivotably attaching the support assembly 158 to the first end 150 of the nitrogen gas strut 22.

When the tailgate 14 is pivoted between the closed position (see FIGS. 1 and 6) and the open position (see FIGS. 2 and 3), the bracket 162 and the shaft 186 rotate relative to the second vehicle sidewall 34. The support 166 rotates with the shaft 186 and thus also the bracket 162, which causes the bell crank 178 to rotate relative to the flange 174.

The second end 154 of the nitrogen gas strut 22 may be fixedly attached to a vehicle endwall 218 of the vehicle body 26. The vehicle endwall 218 may be a laterally extending surface of the vehicle sidewall 34. In this example, the second end 154 of the nitrogen gas strut 22 is attached at a location that is above a bumper 222 of the vehicle 10. However, other implementations are contemplated within the scope of this disclosure.

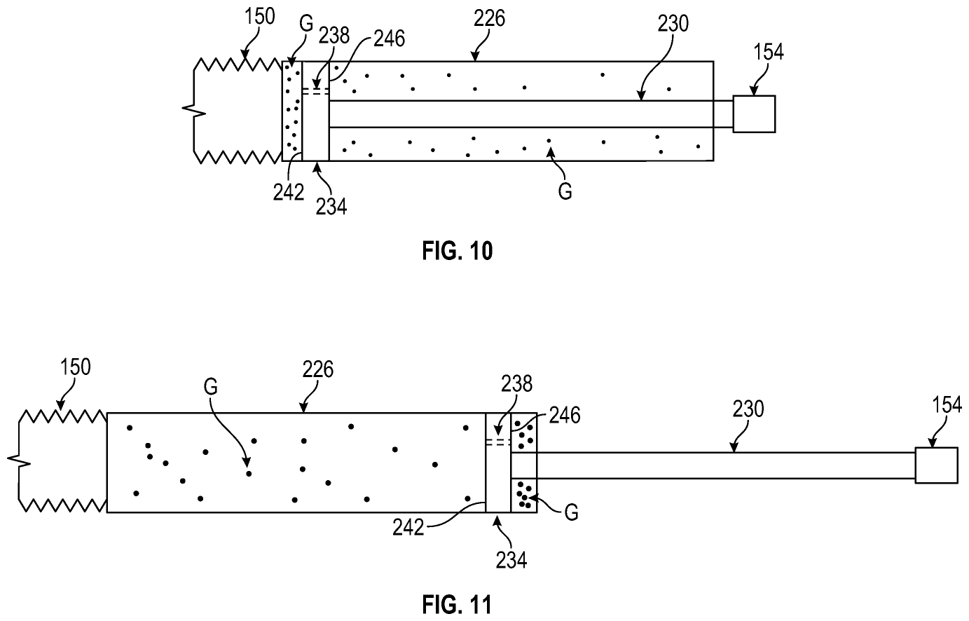

The nitrogen gas strut 22 may be configured as a compressive gas strut with damping capabilities. As shown in FIGS. 10 and 11, for example, the first end 150 may include a sealed container 226 containing pressurized nitrogen gas G, and the second end 154 may include a rod 230 and a piston 234. Nitrogen gas G in the sealed container 226 may pass through an opening 238 provided between a first side 242 of the piston 234 and a second side 246 of the piston 234.

FIG. 10 shows the nitrogen gas strut 22 in a first position when the tailgate 14 is in the closed position (see FIGS. 1 and 6), and FIG. 11 shows the nitrogen gas strut 22 in a second position when the tailgate 14 is in the open position (see FIGS. 2 and 3). When a user pivots the tailgate 14 from the closed position to the open position, the bracket 162, the shaft 186, the support 166, and the bell crank 178 pivot relative to the second vehicle sidewall 34 (see FIGS. 6-9). As the bell crank 178 pivots, the first end 150 of the nitrogen gas strut 22 is pulled in tension away from the second end 154 of the nitrogen gas strut 22, and the nitrogen gas G passes though the opening 238 from the second side 246 of the piston 234 to the first side 242 of the piston 234. The volume of the nitrogen gas G on the first side 242 thereby increases, which in turn increases the amount of pressure applied on the first side 242 and decreases the amount of pressure applied on the second side 246. This pressure differential between the first side 242 and the second side 246 causes the nitrogen gas strut 22 to dampen or control the rate at which the first end 150 moves away from the second end 154. As a result, the nitrogen gas strut 22 may cause the tailgate 14 to pivot more slowly from the closed position to the open position.

When a user pivots the tailgate 14 from the open position to the closed position, the first end 150 of the nitrogen gas strut 22 is pushed in compression toward the second end 154, and the nitrogen gas G passes through the opening 238 from the first side 242 of the piston 234 to the second side 246 of the piston 234. The volume of the nitrogen gas G on the second side 246 thereby increases, which in turn increases the amount of pressure applied on the second side 246 and decreases the amount of pressure applied on the first side 242. This pressure differential between the first side 242 and the second side 246 cause the nitrogen gas strut 22 to apply a second force on the tailgate 14. The second force may be a compressive force that reduces the external force needed for the user to move the tailgate 14 to the closed position.

In this disclosure, like reference numerals designate like elements where appropriate and reference numerals with the addition of one-thousand or multiples thereof designate modified elements that are understood to incorporate the same features and benefits of the corresponding elements.

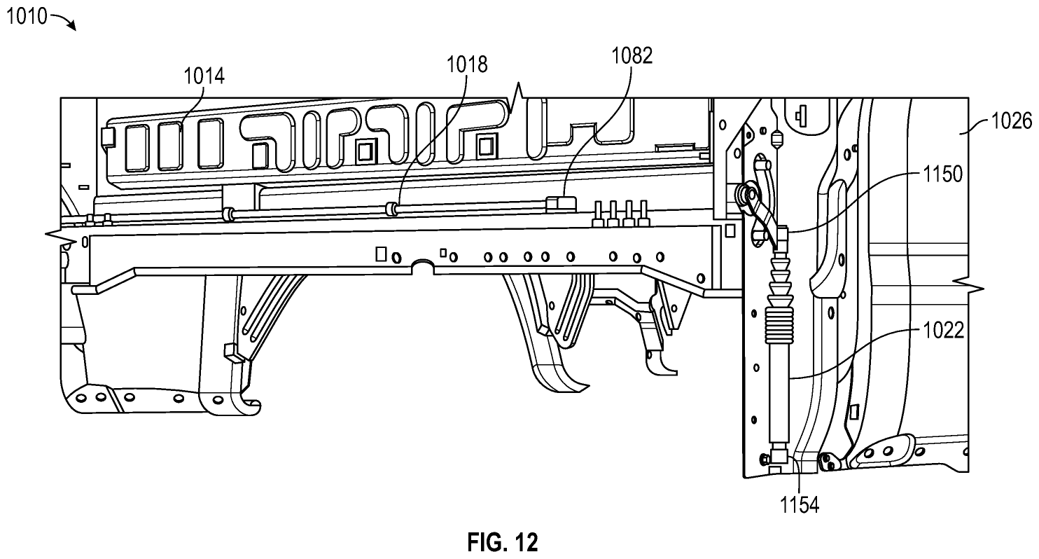

FIG. 12 illustrates another example vehicle 1010. The vehicle 1010 may include a tailgate 1014, a torsion rod 1018, and a nitrogen gas strut 1022. The torsion rod 1018 may be rotatably attached at one end 1046 to a first vehicle sidewall and fixedly attached at an opposite end 1050 to a clamp box 1082. The nitrogen gas strut 1022 may be pivotably attached at a first end 1150 to the tailgate 1014 and fixedly attached at a second end 1154 to a vehicle body 1026. In this example, the second end 1154 may be attached at a location that is vertically below the tailgate 1014. In a particular example, the nitrogen gas strut 1022 is vertically aligned in parallel with the tailgate 1014.

The torsion rods and the nitrogen gas struts of this disclosure are capable of establishing a lift assist system of the vehicle. For example, the torsion rods and the nitrogen gas struts may include features that cooperate for reducing the force needed to move a closure member from an open position to a closed position. The nitrogen gas struts may also include feature for reducing the rate at which a closure member moves from the closed position to the open position.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A vehicle assembly, comprising:
a tailgate configured to pivot between a closed position and an open position; and
a lift assist system connected to the tailgate and including a torsion rod and a nitrogen gas strut,
wherein the lift assist system is configured such that, when the tailgate is pivoted from the open position to the closed position, the torsion rod applies a first force on the tailgate and the nitrogen gas strut applies a second force on the tailgate.

2. The vehicle assembly as recited in claim 1, wherein the torsion rod extends between a first end that is rotatably attached to a support assembly and a second end that is fixedly attached to a clamp box.

3. The vehicle assembly as recited in claim 2, wherein the support assembly includes a flange and a shaft that extends through the flange and rotates relative to the flange, and the first end includes an attachment sleeve that is configured to receive the shaft.

4. The vehicle assembly as recited in claim 2, wherein the clamp box is secured to a lower wall of the tailgate.

5. The vehicle assembly as recited in claim 2, wherein, when the tailgate is pivoted between the closed position and the open position, the second end does not rotate relative to the clamp box.

6. The vehicle assembly as recited in claim 1, wherein the nitrogen gas strut includes a first end that is pivotably attached to a support assembly and a second end that is fixedly attached to a vehicle endwall.

7. The vehicle assembly as recited in claim 6, wherein the vehicle endwall is a laterally extending surface of a vehicle sidewall.

8. The vehicle assembly as recited in claim 6, wherein the second end is above a vehicle bumper.

9. The vehicle assembly as recited in claim 6, wherein the support assembly includes a bracket, a support, a cup, a flange, and a bell crank.

10. The vehicle assembly as recited in claim 1, wherein the nitrogen gas strut is mounted in an open area defined by a vehicle sidewall and an outer panel of a vehicle body.

11. A vehicle assembly, comprising:
a tailgate positioned between a first vehicle sidewall and a second vehicle sidewall, the tailgate configured to pivot between a closed position and an open position;
a torsion rod rotatably attached at a first end to the first vehicle sidewall and fixedly attached at an opposite, second end to a clamp box; and
a nitrogen gas strut pivotably attached at a first end to the tailgate and fixedly attached at an opposite, second end to a portion of the second vehicle sidewall.

12. The vehicle assembly as recited in claim 11, wherein the first end of the torsion rod extends through a first side of the tailgate and is attached to a support assembly that is secured to the first vehicle sidewall.

13. The vehicle assembly as recited in claim 12, wherein the support assembly includes a flange and a shaft that extends through the flange and rotates relative to the flange, and the shaft is received within an attachment sleeve of the first end.

14. The vehicle assembly as recited in claim 11, wherein the second end of the torsion rod includes an attachment section that is received within a channel of the clamp box so that the second end does not rotate relative to the clamp box.

15. The vehicle assembly as recited in claim 11, wherein the first end of the nitrogen gas strut is attached to a support assembly that is secured to the tailgate.

16. The vehicle assembly as recited in claim 15, wherein the support assembly includes a bracket, a support, a cup, a flange, and a bell crank.

17. The vehicle assembly as recited in claim 16, wherein the support includes a slot that is configured to receive a shaft that extends through a second side of the tailgate and the bracket.

18. The vehicle assembly as recited in claim 16, wherein a drive rod extends through the support and the bell crank, and the bell crank includes a post that is attached the second end of the nitrogen gas strut.

19. The vehicle assembly as recited in claim 11, wherein the second end of the nitrogen gas strut is above a vehicle bumper.

20. The vehicle assembly as recited in claim 11, wherein the nitrogen gas strut is mounted in an open area defined by the second vehicle sidewall and an outer panel of a vehicle body.
